(19) United States
(12) Patent Application Publication
(10) Pub. No.: US 2010/0159148 A1
(43) Pub. Date: Jun. 24, 2010

(54) SURFACE COATING COMPOSITIONS

(75) Inventors: Rodger Graham Hagens, Hamilton (CA); Doug Bilbija, Caledonia (CA); Jeremy Hagens, Hamilton (CA)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: CANTECH INDUSTRIAL RESEARCH CORPORATION, Toronto (CA)

(21) Appl. No.: 12/637,250

(22) Filed: Dec. 14, 2009

Related U.S. Application Data
(63) Continuation-in-part of application No. 11/837,644, filed on Aug. 13, 2007, now abandoned.
(60) Provisional application No. 60/836,979, filed on Aug. 11, 2006.

(51) Int. Cl. B05D 1/02

(52) U.S. Cl. 427/427.4

(57) ABSTRACT

Protective coatings, in particular for the purpose of shielding and waterproofing buildings and engineered outdoor structures are based on mixtures of polymer crude tall oil pitch, in particular mixtures of an aqueous emulsions of tall oil pitch with an aqueous polymeric latex. Superior waterproofing/coating compositions according to the invention may be made as a two-component sprayable system comprising a first part which is a mixture of a alkali carbonate modified tall oil pitch emulsion and one or more polymeric latexes, and a second part which is an aqueous solution of a bivalent cationic curing agent.

### FIELD OF THE INVENTION

The present invention is directed to pitch-type waterproofing compositions based on polymer-modified tall oil pitch. More particularly, the present invention is concerned with polymer modified tall oil pitch waterproof compositions that are used for the purpose of shielding buildings and structures against water, moisture and rust, or other damaging aspects of the environment.

More particularly still, the present invention relates to modified tall oil pitch waterproofing compositions that can be instantaneously coagulated by a two-part waterproofing method at ambient temperature that yields a tough weatherproof and chemically resistant membranes.

The present invention is also directed to the use of modifying the properties of tall oil pitch emulsions by means of alkali carbonates and soluble elastomeric polymers in order to confer superior strength, flexibility and resistance to environmental degradation of weather proofing membranes.

### PRIOR ART

The following United States patents disclose a variety of known surface coating compositions currently in use for like applications as the present invention. The disclosure of each of the below-listed US patent documents is incorporated herein by reference for its description of protective waterproofing coating compositions.

### U.S. Patent Documents

| | | |
|---|---|---|
| 3,785,852 | January 1974 | Schleidt |
| 4,287,242 | September 1981 | Monden, et al. |
| 4,437,896 | March 1984 | Partanen |
| 4,822,425 | April, 1989 | Burch |
| 5,021,476 | June, 1991 | Pinomaa |
| 5,671,889 | September 1997 | Petty |
| 5,674,313 | October 1997 | Aoyama, et al. |
| 5,763,014 | June 1998 | Pickett |
| 5,895,347 | April 1999 | Doyle |

### BACKGROUND OF THE INVENTION

### (a) Asphalt-Based Surface Coating Compositions

The term “emulsion” as used herein refers both to chemically stabilized dispersions of water insoluble liquids in water in which the water is the continuous phase (so-called oil in water emulsions), and to those in which the insoluble material is the continuous phase (so called water in oil emulsions). Depending upon the emulsifier used in the process of manufacture, such emulsions may be designated as one of three categories: anionic (alkaline), non-ionic (neutral) or cationic (acidic).

Since asphalt (here considered synonymous with bitumen) emulsions are inadequate for many waterproofing applications, being generally too weak, soft and sticky for the end use required, commercial coating opportunities for these materials involve ‘low end’ applications such as dust control and non demanding vehicular applications such as driveways or road shoulder maintenance.

In order to improve the properties of surface coatings for the protection of various types of surfaces from the elements, it is known to combine asphaltic emulsions with a variety of polymeric emulsions. Such compositions offer a number of advantages in terms of cost and safety, being water based, non-flammable and low in volatile organic compounds. Such formulations may be applied by brushing, rolling, trowelling etc., after which the surface film may be air-dried at ambient temperatures, or by accelerated processes by application of heat. Alternatively such coatings may be applied by means of a two-part spray apparatus by which technique the composition sets and cures very rapidly.

Thus Schleidt (1974) describes a method of applying a bituminous-rubber membrane composition by simultaneously spraying the liquid emulsion composition and a coagulant along spray paths which converge so that the composition and coagulant mix thoroughly before contacting the surface being treated. This invention is said to find particular utility in roofing applications in addition to sound insulating, vibration dampening and vehicle undercoating.

Schleidt was intended as an improvement of other known asphalt emulsion-rubber latex compositions which had previously been applied by brush, troweling or by spraying after which curing was accomplished by air drying, which procedure was time consuming. In this disclosure it is taught that by directing separate streams of chemical coagulant and bituminous emulsion-rubber latex composition along paths which intersect each other at a sufficient distance from the surface to permit thorough comingling of the emulsion-latex composition with the coagulant, the bituminous emulsion and the rubber latex are substantially broken by chemical action of the coagulant, before the materials contact the surface which effected very rapid setting and curing of the membrane composition. In such applications is the asphaltic emulsion is anionic in nature, then the coagulant is cationic. It may also be surmised that if the asphalt emulsion is cationic in nature, then a similar effect might be realised by the utlization of an anionic curing agent.

A wide variety of asphaltic (or bituminous) materials are mentioned in Schleidt where it is also recognized that coal-derived tars and pitches, shale oil residues as well as compatible mixtures of the foregoing might be used. Suitable emulsifying agents and methods of emulsification for forming oil-in-water emulsions of such bituminous materials are well known to those skilled in the art. Representative examples of emulsifying agents include alkali soaps, rosin soaps, casein, proteins, alkyl or alky aryl ethoxylates as well as proprietary surfactants. The curing agents commonly recommended for this application derived from a family of polyvalent metals and their salts, calcium chloride being often preferred for reason of cost, safety and availability.

Thus Monden et al. (1981) describes a spray-coating process which comprises spraying an elastomer modified anionic asphalt emulsion and a polyvalent metal salt simultaneously by means of separate airless type spraying machines to continuously contact and mix said emulsion with said aqueous solution in the space between the spraying machine and the surface of a substrate to be coated and on the substrate surface, thereby forming a rubber-asphalt solid layer on the substrate surface. By this process, a rubber-asphalt solid layer having a thickness of 4 mm or more and having a water-proof, moisture-proof or gas-proof characteristics can be formed rapidly on the substrate surface.

Monden also claims advantages over those methods of brushing or trowelling for which a long period of time is necessary for drying thick applications, and which also tend to form cracks. These advantages are said to be accomplished by spraying a rubber-asphalt emulsion having a total solid content of 70% by weight or more, and a 1-15% by weight aqueous solution of a polyvalent metal salt almost simultaneously from separate airless type spraying machines to continuously contact and mixing said emulsion with said aqueous solution in the space between the spraying machine and the surface of a substrate to be coated and on the substrate surface, thereby forming a rubber-asphalt solid layer on the substrate surface.

According to both Monden's and Schleidt's disclosures the rubber-asphalt emulsion used in this invention is required to be anionic, so that the surfactant employed therein is mainly an anionic one. The elastomeric latexes usable in the rubber-asphalt include natural rubber, styrene-butadiene rubber, butyl rubber, polybutadiene rubber, polyisoprene rubber, chloroprene rubber and the like, and it being preferable that said rubber comprises the styrene-butadiene rubber or modified styrene-butadiene rubber as a main constituent from the viewpoint of performances of rubber-asphalt solid layer and economy.

Pickett (1998) discloses a liquid applied waterproofing formulation system comprising separate formulation components A and B which are transportable to the application site in separate containers and combinable at the site to form a blend, preferably a water-in-oil blend, which solidifies into a continuous membrane having hydrostatic head resistance. Component A is an aqueous latex of a natural or synthetic rubber. Component B is an oil carrier in which is dispersed a vulcanizing agent operative to cure the rubber and a hygroscopic agent operative to chemically bind the water in component A.

For the purpose of alleviating certain problems associated with the gellation of asphaltic-rubber latexes using polyvalent inorganic salts, Aoyama et al. (1997) describes a method of generating contiguous rubberized asphaltic membranes by combining a mixture or cationic asphalt and rubber emulsions with anionic curing agents such as aliphatic and aromatic sulfonates. According to these inventors this process results in the formation of membranes with improved surface adhesion. By elimination of certain inorganic anions such as chlorides, corrosion resistance is also said to be improved. The instantaneously coagulating compositions so described and intended for use in waterproofing, moisture-proofing and rustproofing. The rubber materials usable in the present invention include natural rubber, gutta-percha, cyclized rubber, styrene-butadiene rubber, styrene-isoprene rubber, polyisoprene rubber, butadiene rubber, chloroprene rubber, butyl rubber, halogenated butyl rubber, chlorinated polyethylene, chlorosulfonated polyethylene rubber, ethylene-propylene rubber, EPT rubber, olefin rubber, styrene-butadiene block polymer rubber, styrene-isoprene block polymer rubber, etc.

Although those prior known compositions of the above type have achieved a measure of commercial success, it is well known to those skilled in the art of waterproofing and decorating buildings and other structures with coatings formed from them that they nevertheless suffer from a number of significant disadvantages. The first such is that asphaltic compounds are intensely black in color, so that it is not possible to lighten the texture without adding such quantities of pigment that the physical properties of the coating is undermined.

A second disadvantage is that such asphaltic compositions are susceptible to degradation or dissolution when brought into contact with certain organic solvents such as hydrocarbons and oleophilic materials.

### (b) Tall Oil and Tall Oil Pitch Emulsion Coatings

An alternative known methodology for coating outdoor surfaces is the art of manufacture and application of tall oil and tall oil pitch emulsions. Crude tall oil is a liquid resinous material obtained as a by-product during the digestion of wood chips during pulp and paper manufacture. Such crude tall oils comprise a complex mixture of fatty acids, rosin acids, sterols, higher alcohols, esters, waxes and hydrocarbons.

Crude tall oil is commercially distilled into a family of distilled tall oil materials, broadly divided into the categories of tall oil fatty acids and tall oil resin acids which find wide industrial usage as chemicals in lubricants, emulsifier soaps, adhesives and components in a wide range of specialty chemicals. The residue which remains at the bottom of the distillation tower after distillation is known as tall oil pitch (TOP).

As is the case with asphalt, methods for of manufacturing each category of emulsion from using crude tall oil, distilled tall oil and tall oil pitch are known (Partanen 1984; Burch 1989; Doyle 1999). Such emulsions are commercially available from various suppliers utilizing appropriate emulsification technologies.

Such tall oil or TOP emulsions are typically prepared as compositions containing between 30 and 70% solids by weight (w/w), of which between about 1 and 2% w/w consists of emulsifiers and pH modifiers. A precise chemical description of the emulsions so derived is not usually possible because the base materials (tall oil or TOP) consist of a complex mixture of linear, branched and cyclized hydrocarbons and complex organic compounds.

Burch applied to teach stable single component anionic or non-ionic emulsions of tall oil pitch, which emulsions may be used to provide a coating composition with aggregate that is pliable, weight supporting, freeze resistant and water impermeable. Pinomaa is applied to substitute tall oil rosin (one of the several components in tall oil pitch) in place of bituminous materials in such single component binding agents for aggregates, based on the advantage that it can be colored.

Although asphaltic and TOP emulsions and tall oil emulsions exhibit certain similarities such as thermoelastic flow and provide bonding properties to a wide range of substrates such as aggregates, and as such find similar usage in such fields of application as road and highway construction and maintenance, nowhere in the prior art is the utilization of tall oil pitch, or combinations of tall oil pitch with elastomeric polymers in a two component applications analogous to those used for asphaltic materials described.

Of relevance to the disclosure is the fact that the chemistry of TOP is different from that of asphalt, being characterised by a relatively high abundance of two families of organic acids, tall oil fatty acids and aliphatic rosin acids respectively, in addition to a variety of poorly characterized chemical species known generically as unsaponifiables, the presence of which prohibit a direct replacement of asphalt by tall oil pitch for the manufacture of high performance waterproofing membranes. For such reasons tall oil pitch emulsions on the other hand are generally unsatisfactory for use as paints or water proofing surface coatings in that the films formed from them both weak and extremely tacky.

In the course of searching for a method of improving the properties of polymer modified asphalt emulsions we discovered that certain blends of TOP emulsions with elastomeric polymers could be converted into membranes suitable for use as weatherproofing materials by means of an improved two-component composition.

### SUMMARY OF THE INVENTION

It is a principal objective of the present invention to replace the asphalt in two part coating compositions of the type described in (a) above, by tall oil pitch described in (b), in order to overcome the aforementioned disadvantages of colour, solvent resistance and poor adhesion to certain surfaces mentioned above.

It is a further objective of the present invention to provide coating formulations in which blends of film forming polymeric emulsion with anionic or non-ionic TOP emulsions are shown to be further improved by the incorporation of certain inorganic alkaline carbonates. These membranes resulting from the two-part application of these compostions were found to possess greater strength and solvent resistance than are known from conventional asphalt emulsion-based surface coatings, or any tall oil based membranes heretofore disclosed.

### DETAILED DESCRIPTION OF THE INVENTION

While the improvement of the properties of asphaltic emulsions by means of polymeric admixtures is well known in the art, no such combinations of TOP emulsions with polymer latexes have previously been described. In the course of investigating improved rubberized asphaltic compositions, it was moreover discovered that mixtures of TOP emulsions with polymeric elastomeric latexes and inorganic carbonates allow further improvements over polymer modified asphaltic based compositions.

As illustrated in the Examples below, we have discovered that the blending of TOP emulsions with various polymer modified compositions in combination with specific inorganic alkaline salts, results in products with superior performance properties to those derived from asphaltic emulsions. In addition to being clear materials which can be colorized by means of conventional pigments routinely utilized for the production of paint, such modified TOP compositions exhibit superior resistance to organic solvents and higher strength than those prepared by utilizing bituminous emulsions.

The compositions herein described are thus formulated by combining various soluble polymers, or aqueous emulsions of polymers and co-polymers, certain inorganic alkaline salts with TOP emulsions and combined with the salts of multivalent metals using the two-component process now described. Such compositions not heretofore disclosed in the literature, yield membranes superior to those which derive from asphaltic emulsions in a number of respects. These include higher strength and lower cost in addition to being colorizable and exhibiting greatly excellent resistance to organic solvents and oils such as hydrocarbons, fatty acids, ketones, etc. to which asphaltic compositions are particularly prone.

This improvement may be realized whether the emulsifiers used to manufacture the TOP emulsions are anionic or non-ionic, and depending on the emulsifier of choice such emulsions may be used to improve the performance of a wide range of anionic polymeric latexes well known to the art of surface protection and waterproofing. Such latexes include dispersions of elastomers such as natural rubber, gutta-percha, styrene-butadiene rubber, styrene-isoprene rubber, polyisoprene, polybutadiene, polychloroprenes, organic polysulfides, butyl rubber, halogenated butyl rubber, chlorinated polyethylene, chlorosulfonated polyethylene, ethylene-propylene rubber, butadiene acrylonitrile copolymers, and the like.

Another family of polymeric latexes in which the addition of TOP emulsions may be advantageous is the wide range of non-elastomeric polymers. In particular, we have found that the tall oil emulsions may be used as extenders for a wide range of water soluble dispersions known in the art of surface protection and water proofing. Within this family of products may be mentioned polyvinyl alcohol, polyvinyl acetate, polymethyl methacrylate, polyacrylic, ethylene-vinyl acetate copolymers, ethylene-acrylate copolymers and vinyl acetate-acrylate copolymers, etc. Although these polymer latexes are well known, and have been described for the coating and protection of a variety of surfaces, the advantageous combination with tall oil-emulsion has not previously been disclosed.

As already noted, a method is known by which the application of polymer modified asphaltic emulsions to various substrates is effected in such a way that the coating being applied sets almost instantly. According to this twin spray methodology the polymer modified bitumen composition and a curing catalyst are ejected under moderate pressure through spray nozzles, admixed in the air. By this means various mixtures of asphaltic emulsions and suitably chosen and admixed with the appropriate polymeric latex, are sprayed through one nozzle of a two-part applicator, while a catalytic curing agent is sprayed through the other. Most commonly the polymer modified asphaltic emulsion is anionic in nature, while the curing agent is cationic, most commonly consisting of a soluble salt of a divalent alkali earth mineral such as calcium chloride.

For various reasons related to the chemical stability of the emulsions and the properties of the resulting membrane, it is known in the art that the ratio of bitumen emulsion and the catalytic curing agent must be maintained within a close tolerance. For example, during application of these systems the relative quantity of asphalt emulsion to the preferred curing agent, a saturated solution of one of the preferred curing agents, calcium chloride should be between 35:1 and 30:1. If the quantities of the ingredients lie outside of this range the resulting admixture will either not cure correctly, or the presence of excess catalyst (i.e. free unreacted calcium chloride) will have a deleterious effect on the final cured properties of the membrane. Various attempts to solve this problem with the traditional polymer modified emulsions have so far been unsuccessful. As discussed below, however, utilization of an alkali carbonate modified anionic pitch emulsions has revealed a remarkable and unexpected advantage in this two part application.

Of particular interest therefore was our determination by experiment that some compositions containing TOP emulsion and different polymeric elastomers of the invention described above, can be applied to surfaces by means of double spray systems in which the composition and a curing catalyst are admixed in the air in a manner similar to that known to be used with asphaltic emulsions. According to this art, a mixture of anionicic emulsion and suitably chosen polymeric latex is sprayed through one nozzle of a two-part applicator, and a catalytic curing agent sprayed through the other.

We have now discovered that blends of TOP emulsions and elastomeric polymers in combination with certain alkaline materials can be made to produce a coating which sets instantly when sprayed through a two-part application system in a manner analogous to that known in the case of asphaltic emulsions. It has however been discovered that TOP emulsions possess certain properties which can be utilized to produce water and weather resistant membranes remarkably and unexpectedly superior to those which can be manufactured using asphalt emulsions.

As described in the Examples below, the most efficacious method of utilizing TOP emulsions for the manufacture of elastomeric membranes is to raise the alkalinity of the TOP/polymer admixture to levels well in excess of those capable of being used in the manufacture of bitumen based elastomeric membranes. We have discovered that such high alkaline TOP emulsions exhibit a high degree of physical stability and chemical reactivity quite unlike those that capable of being prepared by addition of alkalis to asphalt emulsions.

Although the chemical mechanism for this procedure is not fully understood, it seems likely that the presence of fatty and rosin acids present in TOP (but absent in asphalt), result in the formation of soluble soaps which stabilize the resulting high alkaline emulsions.

It is further disclosed that the preferred source of alkali to be used in this reaction consists of one of the carbonate salts of the alkali metals lithium, sodium or potassium. It is disclosed here that unlike the situation with asphalt emulsions, when blends of TOP and various polymer dispersions are treated with one or more of the abovementioned alkaline carbonates and then reacted with various metal salts according to the two part process discussed earlier, that the resulting membrane exhibits superior chemical and physical properties. It was further determined that the preferred quantities of the emulsion component (‘Part A’) and the divalent saline curing agent (‘Part B’) is that which conforms to the stoichiometry of the alkaline metal carbonate completely reacting with the divalent saline solution to produce an insoluble divalent metallic carbonate. It is surmised that the improved properties of the resulting membrane shown in the example, may be attributed to the reinforcement of the membrane by this performance enhancing by-product of the reaction. It is further surmised that the properties of this by-product which appears to act as a reinforcing filler, are particularly efficacious because the particles being generated in situ rather than by mechanical grinding, are in all likelihood extremely small, possibly on the nanoscale.

Although the polyvalent metal salt used as a coagulant is not critical, it must be readily soluble in water and excellent in ability to coagulate the emulsion. It is also desirable that this salt be relatively low in cost, and that it have low toxicity, since workers may become exposed to aerosols droplets of this agent during application procedures. For these reasons the range of preferred curing agents is generally limited to the chlorides, nitrates and soluble sulfates of the alkali earth metals calcium, magnesium and aluminum, or such mixed salts as iron alum, potassium alum and the like. In some situations however it may also be desirable to utilize certain inexpensive and non toxic organic cationic materials such as the inorganic salts of certain quaternary ammonium compounds as may be practical to use.

In the preferred method, the additional alkali used in Part A is sodium carbonate, while the divalent salt employed in Part B is a saturated solution of calcium carbonate. Not only are these chemicals readily available, but as shown in the equation below, the only soluble by-product of the reaction consists of the non toxic salt, sodium chloride. Furthermore, the low cost of sodium carbonate and calcium chloride ensures that the resulting membrane finds reinforcement from a very low cost finely divided component.

Na₂CO₃+CaCl₂=CaCO₃+2NaCl (1)

The two-part application may be carried out using equipment and many of the curing agents described in prior art related to polymer modified bituminous emulsions. The curing agent would typically consist of one or more of the soluble salts of polyvalent metals. In a preferred composition Part A would consist of a mixture of an anionic or non-ionic tall oil pitch emulsion, with polychloroprene, acrylic and a styrene-butadiene elastomeric latex, while Part B would consist of the solution of calcium chloride. The preferred concentrations of the various ingredients and the ratio of the volumes of Parts A and B during application depend on the final properties desired, and the details shown in the Examples below are merely illustrative of the types of final properties which might be realized.

The resulting products are superior to the properties of polymer modified asphalt emulsions, in a number of respects.

In the preferred embodiments specifically disclosed herein, the form of TOP advantageous to these application consists of either the anionic and nonionic emulsion, while the most advantageous latexes consist of polychloroprenes (family name Neoprene, DuPont Elastomers), styrene butadience co-polymers (family name Butonal, BASF Corp.) and styrene-acrylic co-polymers (family name Styrez, Halltech Inc.). These groups represent a particularly advantageous combination because of the high strength and flexibility imparted by the Neoprenes, and the excellent adhesion and ultraviolet resistance provided by the acrylics. As will be appreciated by those skilled in the art of coating formulations, various blends of the preferred latexes can be utilized depending on preferred final properties desired.

Moreover these formulations are also amenable to useful modification by additives such as pigments, fillers and process aids known in the art of surface protection, waterproofing and painting. Thus, where exceptional weather resistance is required, this may be achieved by the addition of ultraviolet absorbers known to the art. Similarly, fire resistance can be improved by the incorporation of such chemicals and intumescent agents as are compatible with anionic and nonionic latex mixtures. Likewise, the formulations may be varied by the addition of viscosity modifiers such as thickeners, foam control agents, corrosion inhibitors and stabilizers as known to the art. The formulations may also be further built using insoluble fillers such as clays, ground crumb rubber, mica, polystyrene beads and the like known in the art of surface protection. The compositions may also include fibers. The fiber materials usable in the present invention include synthetic fibers such as glass fibers, rayon silk, vinylon, saran, polypropylene, polyester, polyamide and polyimide, carbon fibers, etc. In required, steel fibers may be used as well. Moreover since these compositions have as formed a light tan color, they may be readily colorized by addition of certain compatible pigments and pigment dispersions.

The two component procedure is strongly preferred over one component composition where the TOP are anionic in nature. This is because the elevated pH in anionic systems results in conversion of the organic acids in the TOP to soluble soaps which render the final composition unsuitable for any application involving exposure to water. The added advantage of the two part process particularly is that the reaction products of the anionic emulsion/polymer blend and the cationic catalyst typically consist of insoluble soaps, most commonly of the alkali earth metals, which have high melting points and excellent bonding properties. Moreover since the preferred salts to be used as curing agents are relatively inexpensive, this procedure has the added advantage of reducing the overall cost of the application.

In the case of Part A being anionic in nature, and Part B being a soluble alkali earth salt, suitable compositions of sprayable consistency will contain from about 60 to about 96 wt % of a tall oil emulsion containing from about 40 to about 70 wt % solids; and from about 2 to about 35 wt % polymer latex containing from about 55 to about 65 wt % solids, and from about 1 to 10% sodium carbonate. The admixture of emulsion and latex is conveniently made by adding the smaller quantity of latex to the larger quantity of emulsion with stirring until homogeneity is obtained. A suitable coagulant can be prepared by forming from about a 3.0 to 32 wt % (i.e. saturated) solution of calcium chloride in water. This solution would then be sprayed at the rate of from about one-fifth to about one-fourth gallons per gallon of the tall oil/polymer emulsion blend.

Compositions herein disclosed exhibit superior properties to the asphaltic polymeric systems previously described, without sacrificing the primary advantages of these compositions. Thus the products here described have low cost, are non-toxic, non-flammable and contain no volatile organic compounds. The results of this process are equal to, and in some ways remarkably superior to those processes heretofore described in the literature. The compositions will be further described in the Examples which follow.

Single component compositions consisting of blends of anionic or non-ionic TOP emulsion in combination with elastomeric polymer dispersions and alkali metal carbonates are also here disclosed. Such compositions may be applied to surfaces either by means of such common practices of wiping, brushing or spraying onto to the substrate, following which the curing of the system is effected by a drying process under ambient conditions. As has been pointed out however, such applications may be considered to have been anticipated by the prior art related to combinations of bituminous coatings and polymer emulsions, in that the similarities between the chemical properties of bituminous and pitch emulsions are close enough, and the chemical resistance of TOP coatings well enough known, that it should not be surprising if similar results are obtained when similar admixtures with polymeric dispersions are prepared. Apart from the improvement in solvent resistance due to the superior chemical properties of crude tall pitch the differences between the single component compositions might be considered to be predictable. As is discussed in the following sections however, we have also determined that a dramatic advancement in the art of waterproofing membranes can be effected by employment of a modified utilization of the two part system referred to above.

### Example 1

### Sodium Carbonate/Styrene Butadiene Modified Tall Oil Pitch (Top) Two Part Compositions

The objective of this example is to illustrate the superior results which may be obtained by replacing asphalt emulsion by an alkali carbonate-polymer modified TOP emulsion in the manufacture of waterproofing membranes by the two-part spray application process, in which the polymer is a styrene butadiene rubber (SBR) dispersion.

The data below compares the properties of cured membranes which are obtained by dual spraying of polymer modified binders and alkaline earth salts.

In the first case, which illustrates the known conventional technology, a polymer modified binder (Part A) consisting of a blend of an anionic asphalt emulsion and a styrene butadiene rubber (SBR) latex is sprayed through one nozzle of a two-part spray applicator, while the curing agent (Part B) consisting of a 10% solution of calcium chloride is sprayed through the second nozzle of the same applicator. The pressure applied to the two spray nozzles is such as to ensure that the ratio of the weights of parts A and B as they interact in the air is between about 10 to 1 and 15 to 1. The duration of the spraying is such that the thickness of membrane applied to the substrate is between about 40 mils (1 mm) and 120 mils (3 mm) after it is fully cured. In the second case Part A consists of a blend of a tall oil pitch emulsion with the same styrene butadiene polymer latex and different quantities of sodium carbonate (soda ash). In this case part B consists of a 31% solution of calcium chloride, and the pressure applied to the two spray nozzles is such as to ensure that the ratio of soda ash to calcium chloride is such as to ensure stoichiometric equivalency as illustrated in equation (1) above.

Details of the various ingredients employed are as follows:

The asphaltic emulsion used in this example was a 60% active anionic emulsion prepared from 52-28 performance grade asphalt using a proprietary anionic emulsifier (Lafarge Asphalt Engineering, Mississauga, Ontario).

The SBR was a 65-69% residue latex sold under the tradename Butonal 1129×(BASF Corporation)
The non-ionic TOP emulsion, 50% active residue was supplied by Enssolutions (Hamilton, Ontario)
Sodium carbonate (soda ash), industrial grade was purchased from (Alphachem, Mississauga, Ontario).

In each case the mixing procedure involved preparation of a blend of the various emulsions in a 1 litre beaker using a laboratory mixer, followed by admixing a saturated solution of sodium carbonate in deionised water (32% w/w).

As illustrated in Table 1, the strength and hardness of the TOP based cured membranes improve as the quantity of soda ash is increased. As shown the maximum quantity of soda ash which may be incorporated is determined by the stability of the starting composition. In the case of the asphalt based composition, such instability prevents the addition of any significant quantity of soda ash to the formula.

TABLE 1

| | #1 | #2 | #3 | #4 | #5 | #6 | #7 |
|---|---|---|---|---|---|---|---|
| Component | % w/w | % w/w | % w/w | % w/w | % w/w | % w/w | % w/w |
| Asphalt emulsion | 75.0 | 71.2 | 0.0 | 0.0 | 0.0 | 0.0 | 0.0 |
| TOP emulsion (non-ionic) | 0.0 | 0.0 | 75.0 | 71.2 | 67.5 | 60.0 | 52.5 |
| SBR latex | 25.0 | 23.8 | 25 | 23.8 | 22.5 | 20.0 | 17.5 |
| Soda ash (32%) | 0.0 | 5.0 | 0.0 | 5.0 | 10.0 | 20.0 | 30.0 |
| Total | 100.0 | 100.0 | 100.0 | 100.0 | 100.0 | 100.0 | 100.0 |
| Product stability | Good | Poor | Good | Good | Good | Good | Poor |
| Cured strength (psi) | 90 | n/a | 70 | 95 | 120 | 125 | n/a |
| Hardness (Durometer 00) | 85 | n/a | 60 | 90 | 93 | 94 | n/a |

### Example 2

### Sodium Carbonate/Polychloroprene/Styrenated Acrylic Modified Tall Oil Pitch (Top) Two Part Compositions

The objective of this example is to illustrate the superior results which may be obtained by replacing asphalt emulsion by an alkali carbonate polymer modified TOP emulsion in the manufacture of waterproofing membranes by the two-part spray application process, in which the polymers consist of a mixture of dispersion.

The data below compares the properties of cured membranes which are obtained by dual spraying of polymer modified binders and alkaline earth salts.

In the first case, which illustrates the known conventional technology, a polymer modified binder Part A) consisting of a blend of an anionic asphalt emulsion and a polychloroprene/styrene acrylic copolymer latexes is sprayed through one nozzle of a two-part spray applicator, while the curing agent (Part B) consisting of a 10% solution of calcium chloride is sprayed through the second nozzle of the same applicator. The pressure applied to the two spray nozzles is such as to ensure that the ratio of the weights of parts A and B as they interact in the air is between about 10 to 1 and 15 to 1. The duration of the spraying is such that the thickness of membrane applied to the substrate is between about 40 mils (1 mm) and 120 mils (3 mm) after it is fully cured. In the second case Part A consists of a blend of a tall oil pitch emulsion with the same polychloroprene/styrene acrylic co-polymer latex and different quantities of sodium carbonate (soda ash). In this case part B consists of a 31% solution of calcium chloride, and the pressure applied to the two spray nozzles is such as to ensure that the ratio of soda ash to calcium chloride is such as to ensure stoichiometric equivalency as illustrated in equation (1) above.

Details of the various ingredients not mentioned in the previous Example are:

Anionic TOP emulsion, 50% active marketed under the name Road Oyl (Midwest Industrial Supply, Canton Ohio).
Polychloroprene latex, 60% residue, Neoprene 671A (Du Pont Elastomers, Freeport Tex.)
Styrene acrylic co-polymer: 50% residue, Styrez HR 2845 (Halltech Inc., Scarborough Ontario).

As illustrated in Table 2, the strength and hardness of anionic TOP based membranes improve as the quantity of soda ash is increased.

TABLE 2

| | #1 | #2 | #3 | #4 | #5 | #6 | #7 |
|---|---|---|---|---|---|---|---|
| Component | % w/w | % w/w | % w/w | % w/w | % w/w | % w/w | % w/w |
| Asphalt emulsion | 75.0 | 71.2 | 0.0 | 0.0 | 0.0 | 0.0 | 0.0 |
| TOP emulsion (anionic) | 0.0 | 0.0 | 75.0 | 71.2 | 67.5 | 60.0 | 52.5 |
| Polychloroprene | 15.0 | 14.3 | 15.0 | 14.3 | 13.5 | 12.0 | 10.5 |
| Styrene acrylic | 10.0 | 9.5 | 10.0 | 9.5 | 9.0 | 8.0 | 7.0 |
| Soda ash (32%) | 0.0 | 5.0 | 0.0 | 5.0 | 10.0 | 20.0 | 30.0 |
| Total | 100.0 | 100.0 | 100.0 | 100.0 | 100.0 | 100.0 | 100.0 |
| Product stability | Good | Poor | Good | Good | Good | Good | Poor |
| Cured strength (psi) | 120 | n/a | 100 | 125 | 145 | 150 | n/a |
| Hardness (Durometer 00) | 90 | n/a | 65 | 90 | 92 | 95 | n/a |

### Example 3

### Solvent Resistance of Single Component Asphalt and Top Compositions

This example is presented in order to demonstrate the superior properties of TOP/polymer membrane compositions compared to those prepared using asphaltic dispersions. The particular example here provided relates to the resistance of membranes prepared from such compositions to organic solvents. As illustrated below, blends of solvent resistant polymers and either anionic or non-ionic TOP emulsions may be used to produce coatings with superior solvent resistance, a property not previously disclosed in the literature. As noted elsewhere such compositions may also be colorized by addition of suitable pigments, or further modified by the addition of fillers, stabilizers and other such additives known in the art.

In order to demonstrate the improved solvent resistance of tall oil emulsions compared to those based on asphalt, a number of polymer modified formulations were prepared and evaluated. The anionic and non-ionic TOP emulsion referred to in Examples 1 and 2, were in this case blended with a number of commercial polymeric latexes known to have good resistance to organic solvents. Aliquots of each were cast into a silicone coated paper and allowed to air cure at 20° C. and 50% RH for 3 days, or to constant weight. Similar samples were prepared using the asphalt emulsion described above. The cured samples when removed from the coated paper were 80 mil (2 mm) thick. Portions of each sample were then exposed separately to two solvents, mineral spirits, xylene, Canola oil and isopropyl alcohol (70%) at 20° C. for various time periods, after which they were removed, dried and weighed.

In these experiments that nitrilo butadiene acrylic co-polymer (acrylonitrile') was a 40% dispersion sold under the name Synthomer 99G 43 (Synthomer GmbH, Germany), while the styrene acrylate was a 50% dispersion sold as Styrez HR 1060 (Halltech Inc., Scarborough Ontario), the polychloroprene was a 60% solids Neoprene 671A (DuPont Elastomers).

As illustrated in Table 3, the strength and hardness of anionic TOP based membranes improve as the quantity of soda ash is increased.

TABLE 3

| | #1 | #2 | #3 | #4 | #5 | #6 |
|---|---|---|---|---|---|---|
| Component | % w/w | % w/w | % w/w | % w/w | % w/w | % w/w |
| Asphalt emulsion | 75.0 | 0.0 | 65.0 | 0.0 | 70.0 | 0.0 |
| TOP emulsion (non-ionic) | 0.0 | 75.0 | 0.0 | 65.0 | 0.0 | 70.0 |
| Polychloroprene | 0.0 | 0.0 | | | 30.0 | 30.0 |
| Acrylonitrile | 25.0 | 25.0 | 0.0 | 0.0 | 0.0 | 25.0 |
| Polyacrylate | 0.0 | 0.0 | 35.0 | 35.0 | 0.0 | 0.0 |
| Total | 100.0 | 100.0 | 100.0 | 100.0 | 100.0 | 100.0 |
| Min. spirits (% loss), 3 min | 18.2 | 13.3 | 30.0 | 5.1 | 18.0 | 12.5 |
| Xylene (% loss), 3 min | 25.0 | 8.5 | 31.6 | 12.3 | 28.0 | 28.0 |
| Canola oil, 18 hours | 24.5 | 8.3 | 14.3 | 2.6 | −20.6* | −3.2* |
| Isopropyl alcohol, 18 hours | 5.3 | 0.0 | 0.0 | 0.0 | 0.0 | 0.0 |

*Negative values indicate undesirable weight gain due to absorption and retention of nonvolatile oil

1. A two-part sprayable waterproofing system comprising, as a first part thereof, a mixture of a tall oil pitch (TOP) emulsion, alkali metal carbonate and a polymeric latex and as a second part thereof an aqueous solution of a curing agent effective, when said two parts are separately sprayed through a twin-nozzle spray unit onto a surface, to effect curing of the sprayed material to a protective coating on the surface.

2. A two-part system according to claim 1, wherein said first part comprises a mixture of an anionic or non-ionic tall oil pitch emulsion, an anionic or nonionic polymeric latex, and an alkali metal carbonate, while the second part is an aqueous solution of an alkaline earth metal salt.

3. A two-part system according to claim 2, wherein said polymeric latex is a member selected from the group consisting of natural rubber, gutta-percha, styrene-butadiene rubber, styrene-isoprene rubber, polyisoprene, polybutadiene, polychloroprenes (Neoprenes), organic polysulfides, butyl rubber, halogenated butyl rubber, chlorinated polyethylene, chlorosulfonated polyethylene, ethylene-propylene rubber, and butadiene-acrylonitrile copolymers.

4. A two-part system according to claim 2, wherein said polymeric latex is a member selected from the group consisting of polyvinyl alcohol, polyvinyl acetate, polyacrylates, polymethyl methacrylate, ethylene-vinyl acetate copolymers, ethylene-acrylate copolymers and vinyl acetate-acrylate copolymers.

5. A two-part system according to claim 1, wherein said first part comprises from about 60 to about 96 weight percent of an anionic or nonionic TOP emulsion containing from about 40 to about 70 weight percent solids, and from about 2 to about 35 weight percent of a polymer latex containing from about 45 to 65 weight percent solids and from about 1 to 10% sodium carbonate.

6. A method of applying a protective coating to a surface, comprising the step of spraying the surface with a mixture of the first and second parts of the two-part system according to claim 1, wherein the first part comprises an aqueous TOP emulsion, a polymeric latex and sodium carbonate, and the second part comprises an aqueous solution of an alkaline earth metal curing agent to effect curing of the sprayed material to form the protective coating on the surface.

7. A method according to claim 6, wherein said aqueous TOP emulsion is an aqueous anionic emulsion of crude tall pitch, said polymeric latex is a latex of polychloroisoprene and said curing agent is calcium chloride.

8. A two-part system according to claim 5, in which the first part further comprises at least one additive selected from the group consisting of pigments, fillers, UV absorbers, fire resistance enhancers and viscosity modifiers.

9. A single component waterproofing composition comprising a mixture of either an anionic or non-ionic tall oil pitch emulsion, an alkali metal carbonate and a polymeric latex.

10. A single component composition according to claim 9, wherein said polymeric latex is a member selected from the group consisting of natural rubber, gutta-percha, styrene-butadiene rubber, styrene-isoprene rubber, polyisoprene, polybutadiene, polychloroprenes, organic polysulfides, butyl rubber, halogenated butyl rubber, chlorinated polyethylene, chlorosulfonated polyethylene, ethylene-propylene rubber, and butadiene-acrylonitrile copolymers.

11. A single component composition according to claim 9, containing from about 60 to about 96 weight percent of a tall oil pitch (TOP) emulsion containing from about 40 to about 70 weight percent solids, and from about 2 to about 35 weight percent of a polymer latex containing from about 55 to 65 weight percent solids and from about 1 to 10% sodium carbonate.

12. A single component composition according to claim 11, further comprising at least one additive selected from the group consisting of pigments, fillers, UV absorbers, fire resistance enhancers and viscosity modifiers.
